(19) United States
(12) Patent Application Publication
(10) Pub. No.: US 2018/0111347 A1
(43) Pub. Date: Apr. 26, 2018

(54) Peel and Stick Non-Skid Stair Cover

(71) Applicant: Adhesive Technologies, LLC, Sarasota, FL (US)

(72) Inventors: Margaret D. Kruger, Sarasota, FL (US); Amy R. Luffman Messick, Chatsworth, GA (US); Onelio E. Recinos, Chatsworth, GA (US)

(73) Assignee: Adhesive Technologies, LLC, Sarasota, FL (US)

(21) Appl. No.: 15/789,060

(22) Filed: Oct. 20, 2017

Related U.S. Application Data
(60) Provisional application No. 62/411,349, filed on Oct. 21, 2016.

(51) Int. Cl. B32B 3/30; C09J 7/02; B32B 5/02; B32B 7/12; B32B 27/12; B32B 27/40; B32B 37/12; B32B 38/00

(52) U.S. Cl. CPC B32B 3/30; C09J 7/0296; B32B 5/022; B32B 7/12; B32B 27/12; B32B 2419/00; B32B 37/12; B32B 38/0004; C09J 2475/006; C09J 2421/00; B32B 27/40

(57) ABSTRACT

A peel and stick skid resistant polyurethane surface with abrasives is provided with a method of manufacture.

This patent application claims priority to U.S. Provisional Application Ser. No. 62/411,349 filed Oct. 21, 2016.

### BACKGROUND OF THE INVENTION

This invention relates to skid resistant surfaces, especially adapted for a peel and stick installation, and optimized for application over existing stair treads.

Frequently it is desirable to provide additional traction on walking surface, and this may be a hard floor surface that is slippery and offers little traction or a worn area or a stair tread or any other traffic area where slips may occur.

Many efforts have been made to improve traction on surfaces and often the solutions become complex and expensive. Some skid resistant applications are intended for use with carpeted surfaces, others attempt to provide extremely durable solutions when a quickly installed but less permanent alternative would be more suitable. Furthermore, many abrasive surfaces that are utilized in providing skid resistant surfaces tend to lose their effectiveness as the abrasive particles are either dislodged or smoothed with wear. It is also necessary that the solution not be so thick as to present a trip hazard when the product is mounted on a stair treads or walkways and the product should be suitable for use in damp environments which tend to exacerbate the risk of slippage.

### SUMMARY OF THE INVENTION

The invention attempts to provide easily installed, inexpensive, abrasive or skid resistant surface. The product can be manufactured so that it can be readily cut to fit in particular locations such as on a stair tread, and preferably provides both ridges and abrasives to resist foot slippage. Inexpensive materials such as polyurethanes with filler, sand or other abrasives, non-woven fabric backing, pressure sensitive adhesive, and release film can be employed and the products manufactured in a continuous manufacturing process to achieve cost efficiencies.

Briefly, in one aspect of the invention, a polyurethane adhesive-type material is applied to the top surface of a non-woven backing, the adhesive preferably extruded in a ridged configuration and before curing, white sand or other cost effective abrasive is dusted on the surface. In addition, the bottom of the non-woven has applied to it lines or a thin layer of pressure sensitive adhesive and a release film is applied to cover that PSA. As the ridged polyurethane adhesive surface cures, it loses its adhesive characteristics, and the product can be rolled or cut in lengths or stacked for shipment.

The peel and stick adhesive, non-woven and cured tread components of the invention are all relatively flexible and the product can conform to the surfaces of stairs or trafficked areas that are not completely flat or level.

### BRIEF DESCRIPTION OF THE DRAWINGS

FIG. 1 illustrates a side sectional view of a peel and stick skid resistant surface according to one embodiment of the invention.

FIG. 2 illustrates exemplary continuous manufacturing method for the skid resistant product of FIG. 1.

### DETAILED DESCRIPTION OF THE INVENTION

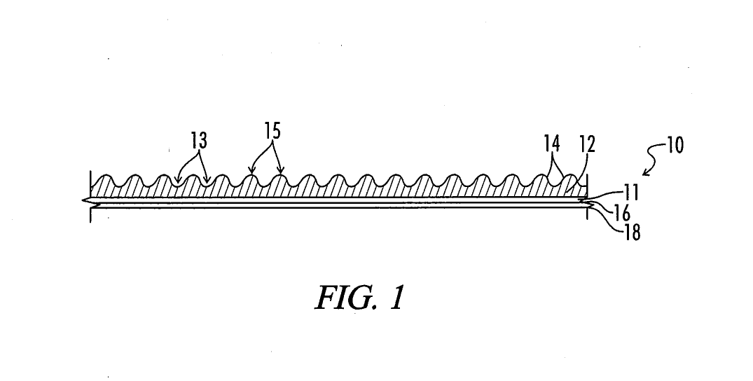

Making reference now to the drawings wherein like numerals indicate like or corresponding parts throughout the figures, FIG. 1 is a side sectional view of a peel and stick skid resistant surface 10 according to one embodiment of the invention. Illustrated are abrasive particles such as aluminum oxide or white sand 14, a ridged surface with valleys 13 and crests 15. The actual body 12 of the skid resistant surface is extruded polyurethane-based material placed on the face of fabric 11, preferably non-woven fabric but the substrate may also be woven or needlepunch material or similar flexible sheeting. On the reverse side of the fabric 11 is pressure sensitive adhesive 16, preferably with moisture resistant properties and a release sheet 18.

It will be understood that the surface may be extruded in a wide variety of widths and lengths, most typically corresponding to the width of stair steps, or from about eight to twelve inches, and in lengths ranging from approximately one foot to continuous rolls of fifty feet or more that can be cut to measure.

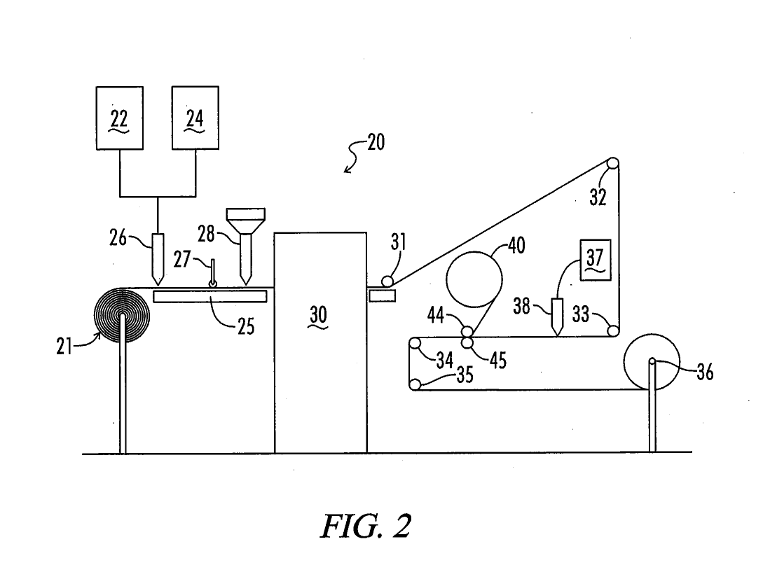

An exemplary manufacturing process for the skid resistant surfaces 10 is shown in FIG. 2. According to the process 20, fabric 21 is advanced across support table 25 and the polyurethane-like substance applied from dispenser 26 which is fed from tanks 22, 24. One tank, 22 would typically contain a polyol component while the second tank 24 will contain the isocyanate component that will be reacted to form polyurethane. A third tank may be utilized for catalysts such DMDEE (2,2′-Dimorpholinodiethylether) and DBTDL (dibutyltin dilaurate) or, in appropriate instances these may be included with the isocyanate. A representative formulation of the material forming the body 12 of the skid resistant tread would be fillers such as calcium carbonate 50 to 70% (and preferably about 60%), plasticizers such as di-isononyl phthalate about 12 to 20% (and preferably about 15-17%), polyol 10 to 25% (and preferably about 15-20%), isocyanate 5 to 10% (and preferably about 7-8%), surfactants from trace (0.01%) to 3%, fatty acids from trace (0.01%) to 5%, moisture scavengers such as PTSI(P-Toluenesulfonyl Isocyanate) less than 1%. Customary additives to provide UV stability, flame retardancy, antibacterial efficacy, and mold and mildew resistance may also be included in the body forming material or the substrate 21 upon which it is dispensed.

After extrusion of the urethane mixture from application head 26 the uncured urethane mixture passes beneath a shaping tool 27 to create a ridged surface. Typically, three to four curved ridges per inch are desired, but V-notches and square notches can also be employed. Next, the ridged urethane passed beneath application head 28 which applies abrasive material such as white sand. The product then passes through a heating chamber 30 to speed the curing of the mixture and thence about guide rollers 31, 32, 33, 34, 35 to allow the application of pressure sensitive adhesive 37 from application head 38 on the underside of the substrate 21. The pressure sensitive adhesive may be applied in a thin continuous sheet or in discreet ribbons across the non-woven surface. Then a release sheet 40 is unrolled and married to the pressure sensitive adhesive by rollers 44, 45 and the completed composite is either cut to length or wound on take-up roll 36.

The finished product may be distributed in roll form in substantial lengths or may be cut to desired lengths such as about three feet and shipped in boxes of about three to twelve pieces. A four piece box of ten to twelve inch wide and three foot long peel and stick step covers is typical.

The ridged abrasive surface product is distributed for use or purchase by consumers. In the case of a desired skid resistant stair, a box of plurality of pre-cut length ridged abrasive surface products may be purchased, the product can be cut to length if too long, using shears or other cutting implements, the release sheet can be removed and the skid resistant surface applied and secured in place by the pressure sensitive adhesive. An appropriate peel and stick pressure sensitive adhesive that could be utilized is DHM-2413, a high tack, low viscosity rubber-based PSA, available from DHM Adhesives, Inc. The non-woven backing fabric is preferred to have a weight of approximately 150 to 250 grams per square meter. Alternative substrates are possible such as woven and needlepunch fabrics or synthetic films, however the moisture and mold resistance and suitable strength of non-woven materials is particularly useful.

Although an embodiment of the present invention has been disclosed herein, it will be understood the various substitution and modifications may be made to the disclosed embodiment described herein without departing from the scope and spirit of the present invention as recited in the appended claims.

What is claimed is:

1. A peel and stick skid resistant surface comprising a ridged polyurethane-based body material, a flexible substrate with a face and a back supporting the body material on its face, a pressure sensitive adhesive on the back of the substrate, and a flexible release sheet covering the pressure sensitive adhesive.

2. The peel and stick skid resistant surface of claim 1 wherein the polyurethane-based body material comprises at least 50% fillers, at least 12% plasticizers, at least 10% polyol, and at least 5% isocyanate.

3. The peel and stick skid resistant surface of claim 2 wherein the polyurethane-based body material comprises no more than 70% fillers, no more than 20% plasticizers, no more than 25% polyol, and no more than 10% isocyanate.

4. The peel and stick skid resistant surface of claim 3 wherein the polyurethane-based body material further comprises 0.01 to 3% surfactants and 0.01 to 5% fatty acids.

5. The peel and stick skid resistant surface of claim 3 wherein ridges on the ridged polyurethane based body material are crests separated by valleys and run longitudinally on the surface with the lateral spacing of the crests between 0.25 and 0.33 inches.

6. The peel and stick skid resistant surface of claim 5 wherein the shapes of the crests and valleys are curved.

7. The peel and stick skid resistant surface of claim 5 wherein the shapes of the valleys are selected from the group of V-notch and square notch shapes.

8. The peel and stick skid resistant surface of claim 3 wherein the flexible substrate is a non-woven fabric.

9. The peel and stick skid resistant surface of claim 3 wherein the pressure sensitive adhesive is moisture resistant.

10. The peel and stick skid resistant surface of claim 9 wherein the pressure sensitive adhesive is rubber-based with high tack and low viscosity.

11. The peel and stick skid resistant surface of claim 5 wherein the lateral width of the surface is between 8 and 12 inches.

12. The peel and stick skid resistant surface of claim 1 wherein the ridged polyurethane-based body material has an abrasive surface.

13. The peel and stick skid resistant surface of claim 12 wherein the abrasive surface comprises sand.

14. The peel and stick skid resistant surface of claim 3 wherein the polyurethane-based body material comprises about 60% fillers, about 15-17% plasticizers, about 15-20% polyol, about 7-8% isocyanate, about 0.01 to 3% surfactants, about 0.01 to 5% fatty acids, and up to about 1% moisture scavengers.

15. A method of manufacturing a peel and stick surface tread comprising mixing a polyurethane-like material comprising 50-70% fillers, 12-20% plasticizers, 10-25% polyol and 5-10% isocyanate, dispensing the polyurethane-like material on a face side of a substrate being advanced longitudinally across a support, shaping the uncured polyurethane-like material to have a longitudinally ridged surface, applying an abrasive material to the uncured ridged polyurethane-like material, curing the polyurethane-like material, applying a pressure sensitive adhesive to a back side of the substrate, and marrying a release sheet to the pressure sensitive adhesive.

16. The method of claim 15 wherein the mixing polyurethane-like material includes a catalyst.

17. The method of claim 15 further comprising cutting the peel and stick surface tread into lengths of about three feet and placing a plurality of such three foot lengths into a box.

18. The method of claim 15 wherein the substrate is a non-woven fabric.

19. The method of claim 15 wherein the pressure sensitive adhesive is rubber-based with high tack and low viscosity.

20. The method of claim 15 wherein the shapes of the longitudinal ridges is curved.
